(19) United States
(12) Patent Application Publication
(10) Pub. No.: US 2011/0150385 A1
(43) Pub. Date: Jun. 23, 2011

(54) POLARIZATION MAINTAINING LARGE CORE HOLLOW WAVEGUIDES

(76) Inventor: Pavel Kornilovich, Corvallis, OR (US)

(21) Appl. No.: 13/061,455

(22) PCT Filed: Sep. 24, 2008
(86) PCT No.: PCT/US08/77542

§ 371 Date: Feb. 28, 2011

(51) Int. Cl. G02B 6/00

(52) U.S. Cl. 385/11

(57) ABSTRACT

A system and method for guiding polarized light is disclosed. One system comprises a large core hollow waveguide having first and second dimensions that are substantially perpendicular. The first and second dimensions are orthogonal to a direction of travel of light in the waveguide. A length of the first dimension is substantially greater than a length of the second dimension to enable light waves with an electric field approximately parallel with the first dimension to propagate through the waveguide with substantially less loss than light waves that have an electric field approximately parallel with the second dimension.

### BACKGROUND

As computer chip speeds on circuit boards increase to ever faster speeds, a communications bottleneck in inter-chip communication is becoming a larger problem. One likely solution is to use fiber optics to interconnect high speed computer chips. However, most circuit boards involve many layers and often require tolerances in their manufacture of less than a micron. Physically placing fiber optics and connecting the fibers to the chips can be too inaccurate and time consuming to be widely adopted in circuit board manufacturing processes.

Routing the optical signals around and between circuit boards can add significant additional complexity. Marketable optical interconnects between chips have therefore proven illusive, despite the need for broadband data transfer.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1a is an illustration of a host layer carried by a substrate in accordance with an embodiment of the present invention;

FIG. 1b illustrates a channel formed in the host layer of FIG. 1a in accordance with an embodiment of the present invention;

FIG. 1c illustrates a reflective coating and protective layer applied over the channel of FIG. 1b to form a base portion in accordance with an embodiment of the present invention;

FIG. 1d illustrates a lid portion having a reflective coating and a protective layer in accordance with an embodiment of the present invention

FIG. 1e illustrates the lid portion coupled to the base portion of FIG. 1c in accordance with an embodiment of the present invention;

FIG. 2 is an illustration of a rectangular large core hollow waveguide in accordance with an embodiment of the present invention;

FIG. 3 is a chart depicting a line of constant propagation loss for a light wave in a large core hollow waveguide of varying size;

FIG. 4 is an illustration of a light beam having an electric field directed parallel with a longer wall of a rectangular large core hollow waveguide in accordance with an embodiment of the present invention;

FIG. 5 is an illustration of a curved rectangular large core hollow waveguide in accordance with an embodiment of the present invention;

FIG. 6 is an illustration of a rectangular large core hollow waveguide in accordance with an embodiment of the present invention;

FIG. 7a illustrates a block diagram of a photonic guiding device in accordance with an embodiment of the present invention;

FIG. 7b illustrates a rectangular large core hollow waveguide used to interconnect two circuit boards in accordance with an embodiment of the present invention;

FIG. 7c illustrates a rectangular large core hollow waveguide used to interconnect electronic components on a circuit board in accordance with an embodiment of the present invention;

FIG. 8a illustrates a one dimensional array of rectangular large core hollow waveguides having a reflective coating and a protective layer in accordance with an embodiment of the present invention;

FIG. 8b illustrates a three dimensional array of rectangular large core hollow waveguides having a reflective coating and a protective layer in accordance with an embodiment of the present invention; and

FIG. 9 is a flow chart depicting a method for transmitting a polarized light beam.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENTS

One method for forming optical interconnects between computer chips on a circuit board is to use optical waveguides formed on the circuit board. Optical waveguides can be superior to fiber optic communications because of the ability to form the waveguides on the circuit board using lithographic or similar processes. The waveguides are typically formed on the circuit boards with substantially optically transparent material, such as polymers and/or dielectrics. Optical waveguides made using lithographic or similar processes can also be formed on other types of substrates that are not mounted on a circuit board. For example, optical waveguide(s) may be formed on a flexible substrate to create a ribbon cable having one or more optical waveguides. The optical waveguides disclosed in this application are formed on substrates using lithographic or similar processes.

Forming optical waveguides in this fashion can provide interconnects that are constructed with the necessary physical tolerances to be used on modern multi-layer circuit boards. However, the polymers, dielectrics, and other materials that can be used in chip and circuit board manufacture to form the on-board waveguides are typically significantly more lossy than fiber optics. Indeed, the amount of loss in on-board waveguides has been one of the factors limiting the acceptance of optical waveguide interconnects. Polymers used to construct the waveguides can have a loss of 0.1 dB per centimeter. In contrast, the loss in a fiber optic is around 0.1 dB per kilometer. Thus, polymer waveguides can have losses that are orders of magnitude greater than the loss in fiber optics.

In addition, typical waveguides are usually manufactured to have dimensions that are roughly proportional with the wavelength of light they are designed to carry. For example, a single mode waveguide configured to carry light waves having a wavelength of approximately 1000 nm may have a dimension of 1000 nm to 5000 nm (1 μm to 5 μm) for the higher index core region and surrounded by a lower index cladding region. Multimode waveguides may have larger dimensions on the order of 20-60 micrometers for the core region. Both single and multimode waveguides have a relatively high numerical aperture (NA) of around 0.2 to 0.3 for a core and clad refractive index contrast of 0.01 to 0.02. The numerical aperture determines the divergence of beam from the emitting fiber. Thus, a larger NA will result in poor coupling as a function of fiber to fiber separation. Thus, connecting waveguides of this size can be expensive and challenging.

Splitting and tapping of the guided optical beams are also difficult to accomplish using these waveguides. The cost of creating and connecting waveguides has historically reduced their use in most common applications. In accordance with one aspect of the invention, it has been recognized that an inexpensive photonic guiding device is needed that is simpler to interconnect with other waveguides and optical devices and that can significantly reduce the amount of loss in an optical waveguide.

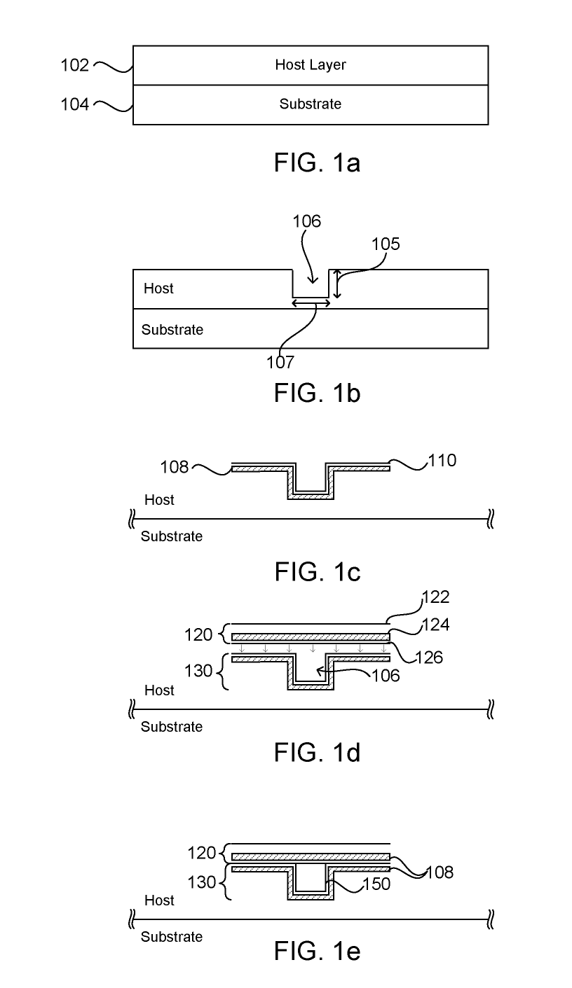

FIGS. 1a through 1e provide an illustration of one method of making a photonic guiding device. This optical waveguide is comprised of a hollow core with a high reflective cladding layer. It operates on the principle of attenuated total internal reflection. This is different from conventional optical waveguides which rely on total internal reflection at the critical angle formed between the core and clad of the waveguide. FIG. 1a shows a host layer 102 being carried by a substrate 104. The substrate may be comprised of a variety of different types of materials. For example, the substrate may be a flexible material such as plastic or a printed circuit board material. The plastic or circuit board material can be configured to be rigid or flexible. Alternatively, the substrate may be formed of a semiconductor material.

The host layer 102 can be formed on top of the substrate material. The host layer may also be a type of flexible material such as a polymer or a semiconductor material to enable the material to be processed using standard lithographic processes. A channel 106 can be formed in the host layer, as shown in FIG. 1b. For example, a dry etching process may be used to form the channel. Alternatively, a molding or stamping process may be used. The shape of the channel can be rectangular, square, circular, or some other geometry used to efficiently transmit light. The height 105 and/or width 107 of the channel can be substantially greater than a wavelength of the light that is directed in the photonic guiding device. For example, the height or width may be 50 to over 100 times greater than the wavelength of the light.

To facilitate a reduction in scattering of the light within the photonic guiding device, the walls of the channel can be smoothed to reduce or eliminate roughness. Ideally, any extruding features along the walls should be less than a wavelength of the light. The walls of the channel can be smoothed using a heat reflow process. This process entails heating the host and substrate material to a temperature that would enable irregular rough features left over from etching or stamping the channel to be substantially reduced or eliminated. The temperature at which the heat reflow process is optimal is dependent on the type of material used to form the host 102 and substrate 104 layers. Another possibility is oxidation of the sidewalls followed by etching of the oxide thus formed.

In order to increase the reflectivity within the channel, a cladding layer 108 (FIG. 1c) may be added to cover an interior of the channel 106 in the host layer 102. The cladding can be formed using an electroplating, electroless plating, sputtering, or similar process, as can be appreciated. If the host material 102 comprises a polymer or other material with a low melting point, the cladding may be applied using a low temperature process such as electroplating, electroless plating, sputtering or thermal evaporation.

The cladding 108 can be comprised of one or more layers of metals, dielectrics, or other materials that are substantially reflective at the wavelength of the coherent light. The metals can be selected based on their reflectivity. A highly reflective cladding layer covering the channel is desired. For example, the cladding layer may be formed using silver, gold, aluminum, platinum, copper, or some other metal or alloy that can form the highly reflective layer. An adhesion layer such as titanium may also be used to help the adhesion of the cladding metal to the host material 102. The cladding layer may also undergo a heat reflow or similar process to smooth rough anomalies in the reflective layer that may occur during the deposition process. Electro-polishing may also be used to yield a smooth mirror finish.

If the photonic guiding device is not protected, the cladding layer 108 may oxidize over time. Oxidation of the reflective coating can substantially reduce its reflectivity. To reduce or eliminate degradation of the cladding layer's reflectivity, a protective layer 110 can be formed over the cladding layer to act as a sealant. The protective layer can comprise a material that is substantially transparent at the wavelength of the coherent light. For example, the protective layer can be formed of silicon dioxide or some other material that can form a substantially air tight bond over the reflective coating. Moreover, the thickness and index of the protective layer is chosen so as to further reduce the propagation loss in the waveguide by separating the light beam from the more lossy metal layer.

The channel 106, cladding layer 108, and protective layer 110 can form a base portion 130 of the photonic guiding device, as shown in FIG. 1d. A lid portion 120 can be formed of a cover material 122 that is layered with a cladding layer 124 and a protective layer 126 configured to protect the reflective coating on the lid portion from oxidizing. The cladding layer and the protective layer can be formed using the same materials as previously discussed in the base portion. Alternatively, different materials may be used based on desired properties of the lid portion.

The cover material can be formed of a material configured to receive the reflective coating and the protective layer. A flexible material may be selected that will allow the photonic guiding device to be flexible. For example, the photonic guiding device may be formed as a ribbon cable that can be used to interconnect electronic or optical devices.

After the lid portion 120 has been formed, the lid portion can be laminated or bonded to the base portion 130, as illustrated in FIG. 1e. When the lid portion is bonded to the base portion, a large core hollow waveguide 150 is formed. The large core hollow waveguide has a cladding layer 108 covering an interior of the hollow waveguide. The cladding layer enables light to be reflected from a surface of the metal coating to reduce attenuation of the light as it is directed through the waveguide.

One challenge in propagating a light beam through a large core hollow waveguide is the amount of space that the waveguides use, especially in chip to chip communications. A typical large core hollow waveguide may have a cross sectional area with a height and width that is each approximately 150 microns. As chip sizes continue to shrink, the area used by the large core hollow waveguides on a circuit card can be considerable. Additionally, it can be difficult to maintain a particular polarization of light in a hollow metal waveguide, such as the waveguide illustrated in the example in FIG. 1e. Many types of optical chip components are designed to use a particular polarization of light. Any substantial change in the polarization that occurs during transit through a waveguide can result in considerable optical loss at the chip components.

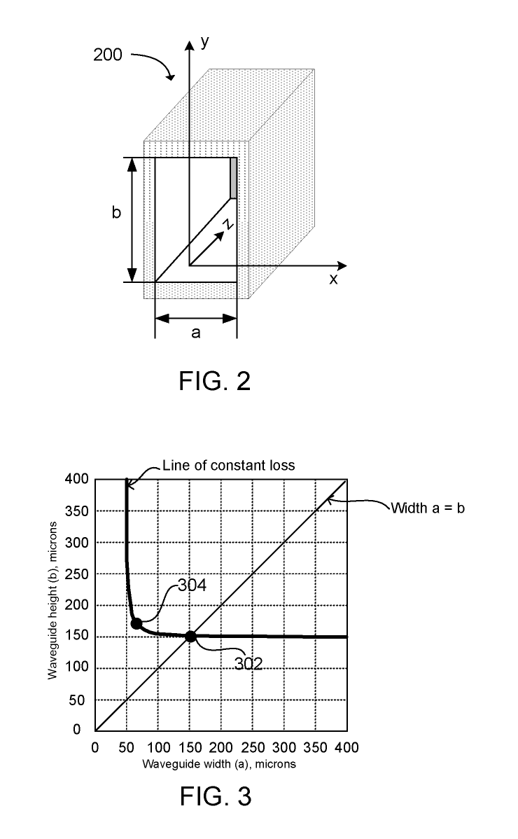

In accordance with one embodiment of the invention, a large core hollow waveguide, as illustrated in an exemplary embodiment in FIG. 2, can be designed to maintain a particular polarization state. In one embodiment, a particular polarization state of a light beam can be maintained by controlling the aspect ratio of a first dimension (a) relative to a second dimension (b) of the hollow metal waveguide relative to the polarization of the light waves. A brief review of the principles of propagation of electromagnetic waves can help to understand this principal.

As can be understood through Maxwell's equations, electromagnetic waves propagate through air with an electric field E and a magnetic field H. The electric and magnetic fields are mutually orthogonal and both are, in general, orthogonal to the direction of propagation. The direction of the electric field is typically referred to as “polarization”. For example, if the electric field is said to be polarized in the x axis, then the magnetic field is directed in the y axis that is orthogonal to the x axis. This can be denoted E^{X} and H^{Y}. Electromagnetic waves can then propagate along the z axis. The electromagnetic waves can also propagate in modes. The modes can be designated as p and q, representing the number of lobes in the mode profile along the x and y axis, respectively. This leads to a designation of E^{X}_{pq} and H^{Y}_{pq} for a light wave traveling along the z axis with the electric field in the x axis. The lowest order mode is p=1 and q=1, or E^{X}₁₁ and H^{Y}₁₁. For a light wave traveling with the electric field in the Y dimension, the modes are designated E^{Y}_{pq} and H^{X}_{pq}.

Propagation losses for the electric field in a large core hollow waveguide can be derived. For an empty core (n_{core}=1), the loss constant α, for the electric field in the x and y dimension, respectively, have the form:

$${α}_{{E}_{pq}^{X}} = \frac{{λ}^{2} {p}^{2}}{2 {a}^{3}} Im ( \frac{{n}_{clad}^{2}}{\sqrt{1 - {n}_{clad}^{2}}} ) + \frac{{λ}^{2} {q}^{2}}{2 {b}^{3}} Im ( \frac{1}{\sqrt{1 - {n}_{clad}^{2}}} ) ;$$

$${α}_{{E}_{pq}^{Y}} = \frac{{λ}^{2} {p}^{2}}{2 {a}^{3}} Im ( \frac{1}{\sqrt{1 - {n}_{clad}^{2}}} ) + \frac{{λ}^{2} {q}^{2}}{2 {b}^{3}} Im ( \frac{{n}_{clad}^{2}}{\sqrt{1 - {n}_{clad}^{2}}} ) ,$$

where λ is the wavelength of the light, n is the complex index of refraction of the cladding material, p and q are the modes of the electric field, and a and b are the dimensions of waveguide in the x and y directions, respectively. The first term describes the propagation losses induced by the vertical walls separated by (a), whereas the second term describes the propagation losses induced by the horizontal walls separated by (b). It should be noted that the dimensionality of a is inverse length. Propagation loss in units of dB/length is given by dB/length=8.686α.

Because the n² value in the numerator is only associated with one dimension, that dimension can have significantly more loss. For example, when a silver cladding is used, the value of n² is approximately 32 at the wavelength of λ=850 nm. When a gold or copper cladding is used, the value of n² at the same wavelength is approximately 31 and 29, respectively. When a=b (a square waveguide), and E^{Y} modes are used the vertical (i.e. parallel to electric field) walls induce about 30 times less loss than the horizontal (i.e. perpendicular to electric field) walls, as may be deduced from the second of the above formulas. If E^{X} modes are used, the horizontal walls induce about 30 times less loss than the vertical. Thus, for a square waveguide, the walls parallel to the electric field induce much less propagation loss that the walls perpendicular to the electric field.

As a consequence, the loss has different sensitivity to changes of waveguide parameters. That is, when vertically polarized E^{Y} modes are used, there is relatively little change in the amount of loss with a change in the distance between the vertical walls (parameter a). However, the loss changes significantly more (at a rate of about 30×) with the distance between the horizontal walls (parameter b). Thus, one can significantly reduce waveguide dimension (a), and compensate for the resulting increased amount of loss with a slight increase of the waveguide dimension (b). Since a reduced height or width decreases the area occupied by the waveguide, working with polarized light, in principle, can save a substantial amount of real estate on a chip.

For example, FIG. 3 illustrates a graph showing a line of constant loss relative to size in a waveguide having a width (a) and a height (b), measured in microns. The line of constant loss in this example is a value of 0.0015 dB/cm. A square waveguide 302, is marked on the graph showing a width and a height of 150 microns. It can be seen that a rectangular waveguide 304 having a substantially reduced width (˜65 microns), with a relatively small increase in height (˜170 microns) can have substantially the same propagation loss as the square waveguide. The cross sectional area of the rectangular waveguide is reduced from 22,500 square microns for the square waveguide to 11,050 square microns for the rectangular waveguide. Thus, the rectangular waveguide has an area that is less than half the square waveguide, with a substantially similar amount of loss as the light propagated in the square waveguide.

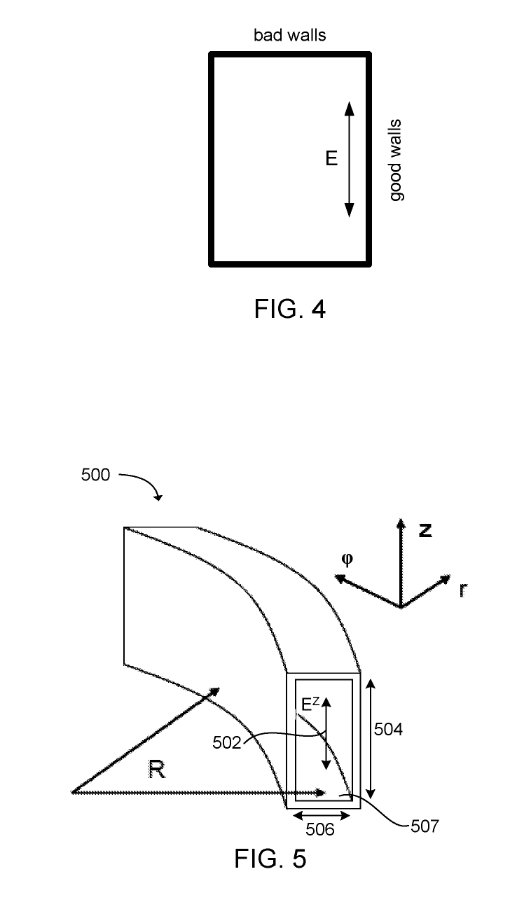

In general, losses of both the E^{X}_{pq} and the E^{Y}_{pq} mode types follow the same scaling law. The losses increase proportional to the square of the wavelength of the light, and reduce inversely proportional to the cube of the waveguide dimension: (propagation loss)˜(X²/(waveguide dimension)³). However, the first waveguide dimension and the second waveguide dimension (width and height) contribute to losses unequally. For a given mode type (fixed polarization), the walls parallel to the electric field cause relatively small losses, whereas the walls perpendicular to the electric field cause relatively large losses. The ratio of the two loss types is about the absolute value of n²_{clad}, as previously discussed. Thus, the walls parallel to the electric field can be considered as relatively low loss walls, while the walls perpendicular to the electric field can be considered relatively high loss walls. This is generally illustrated in FIG. 4, showing a large core hollow waveguide with an electric field E. The walls of the waveguide that are parallel with the electric field have substantially lower loss than the walls that are perpendicular with the electric field. Therefore, when a rectangular waveguide is used, the electromagnetic waves can be propagated with the electric field in a direction parallel with the longer walls of the waveguide to minimize loss.

The electromagnetic waves propagated in a rectangular large core hollow waveguide, such as an infrared or visible light beam, will have substantially more loss in the perpendicular direction of the electric field relative to the parallel direction. This results in the beam becoming highly polarized in the parallel direction as it travels through the waveguide. Transmitting a substantially randomly polarized beam through a large core rectangular hollow waveguide will result in a relatively high loss for electromagnetic waves in the beam that are perpendicular to the long walls in the waveguide. A beam that is already polarized parallel to the long walls will have its polarization maintained as it travels through the waveguide with a relatively low amount of loss. This enables optical components that rely on a particular type of polarization to be used in the communications architecture.

Working with polarized light and asymmetric rectangular waveguides can add extra benefits. One dimension of the rectangular waveguide can be significantly reduced without impacting the overall absorption loss. This can save a significant amount of real estate on a computer circuit board and/or computer chip. By reducing a width of the waveguide and increasing its height, the overall area used in a circuit board is reduced, thereby enabling smaller circuit boards to be used.

Because the propagation loss is different for the parallel and perpendicular walls, it can be beneficial to use different types of dielectric coatings on the walls. For example, a first type of dielectric coating may be used for the waveguide walls that are parallel with the electric field of the light propagated through the waveguide. A second type of dielectric coating can be used for the walls that are perpendicular to the electric field. The dielectric coating provides an additional interface between the two waves to allow penetration of the electric field into the metal cladding to be either maximized or minimized, as desired. An optimal thickness of the dielectric coating can be selected to maximize reflectivity of s and p polarizations of the light waves propagating in the waveguide.

In order to build a robust communications architecture, low propagation loss in straight segments is typically not sufficient. Obtaining a desired transmission through a curved waveguide segment may be needed to route optical signals between chips and boards. These curved segments can be used to form bends in the waveguides. An exemplary embodiment of a large core hollow waveguide 500 having a radius of curvature R is illustrated in FIG. 5. As in the straight waveguides, the curved waveguide can include a first dimension 504 that is substantially greater than a second dimension 506. Where the ratio of the radius R of curvature of the waveguide relative to the wavelength λ of the propagated beam is much greater than one (R/λ>>1), the propagation loss for the lowest order mode for a light beam with an electric field 502 perpendicular to the bend plane can be solved analytically with some approximations to provide the following result:

$${α}_{{E}_{11}^{Z}} = \frac{1}{R} Im ( \sqrt{\frac{{n}_{core}^{2}}{{n}_{core}^{2} - {n}_{clad}^{2}}} ) = \frac{1}{R} Im ( \sqrt{\frac{1}{1 - {n}_{clad}^{2}}} ) .$$

For example, when using a large core hollow waveguide having a silver cladding and propagating a light beam with a wavelength of 850 nm (n_{clad}=0.152+i*5.678), the loss is α_{E}_{₁₁}_{^{z}}=(0.039/R) dB/cm, where the radius R is measured in centimeters. Thus, the loss a is the loss per unit length and is inversely proportional to the bend radius. The linear length of a bend is, for most geometries, proportional to the radius. As a result, the total loss per bend is roughly independent of the bend radius in a large core hollow metallic waveguide. For the E^{Z}₁₁ mode in a silver coated waveguide, with the electric field perpendicular to the bend plane, the total loss after passing through a 90 degree bend is about 0.06 dB. In the exemplary illustration in FIG. 5, the bend plane would be a plane that is parallel with a floor 507 (or ceiling) of the curved waveguide. Thus, the electric field 502 of the polarized light waves is perpendicular to the floor and ceiling of the curved waveguide.

In E^{r} modes, the electric field is along the radial coordinate. In other words, it is parallel to the bend plane (perpendicular to the floor 507). The propagation loss for the lowest order mode for a light beam with an electric field parallel to the bend plane can be solved analytically with some approximations to provide the following result:

$${α}_{{E}_{11}^{r}} = \frac{1}{R} Im ( \frac{{n}_{clad}^{2}}{{n}_{core}^{2}} \sqrt{\frac{{n}_{core}^{2}}{{n}_{core}^{2} - {n}_{clad}^{2}}} ) = \frac{1}{R} Im ( \frac{{n}_{clad}^{2}}{\sqrt{1 - {n}_{clad}^{2}}} )$$

This loss coefficient with the electric field parallel to the bend plane is roughly a factor of n²_{clad} larger than that of the E^{Z} mode. Thus, as in the case of propagation of a light beam through a straight waveguide, the polarization with an electric field that is perpendicular to the waveguide wall (in this case the outer curved wall that is responsible for most of the propagation loss) suffers much higher losses than the polarization with an electric field that is parallel to the wall. For silver cladding at 850 nm, α_{E}_{₁₁}_{^{R}}=(1.34/R) dB/cm, where the radius R is measured in centimeters. The total absorption loss of a 90-degree bend is approximately 2.1 dB. It should be noted that these losses are theoretical lower limits. In practice, there is also additional loss associated with sidewall scattering and other effects. However the overall loss is typically not smaller than these theoretical values.

Thus, for a communications architecture that included five 90-degree bends in the large core hollow metallized waveguide, a polarized light beam with an electric field that is perpendicular to the bend plane has a loss of about 0.06*5=0.3 dB. For a polarized light beam with an electric field that is parallel to the bend plane, the loss is about 2.1*5=10.5 dB. The latter amount of loss generally cannot be sustained in chip to chip communications using low powered lasers or light emitting diodes to communicate. Thus, a polarization scrambled beam transmitted through a large core hollow waveguide would result in a light beam with substantial losses in the electric field that is parallel to the bend plane. Therefore, when using large core hollow waveguides with bends, it is beneficial to use a polarization that is substantially perpendicular to the bend plane to limit losses, as illustrated in FIG. 5. Axes for the cylindrical coordinate system are shown using the cylindrical coordinates φ, r, and z.

The ratio of the typical propagation loss through a bend in a waveguide relative to a typical propagation loss in a straight waveguide is on the order of the (waveguide width)³/(wavelength)²/(curvature radius). For a waveguide width of approximately 100 micrometers, a wavelength of about 1 micrometer, and a radius of about 10,000 micrometers (1 cm), the ratio is about 100. Thus, the bend losses are about 2 orders of magnitude larger than the straight losses. Therefore, limiting the number of curves in a large core hollow metallized waveguide communication architecture significantly decreases the amount of losses. However, when curves are needed, the use of rectangular waveguides with a light beam having an electric field polarization perpendicular to the bend plane of the waveguide can minimize losses.

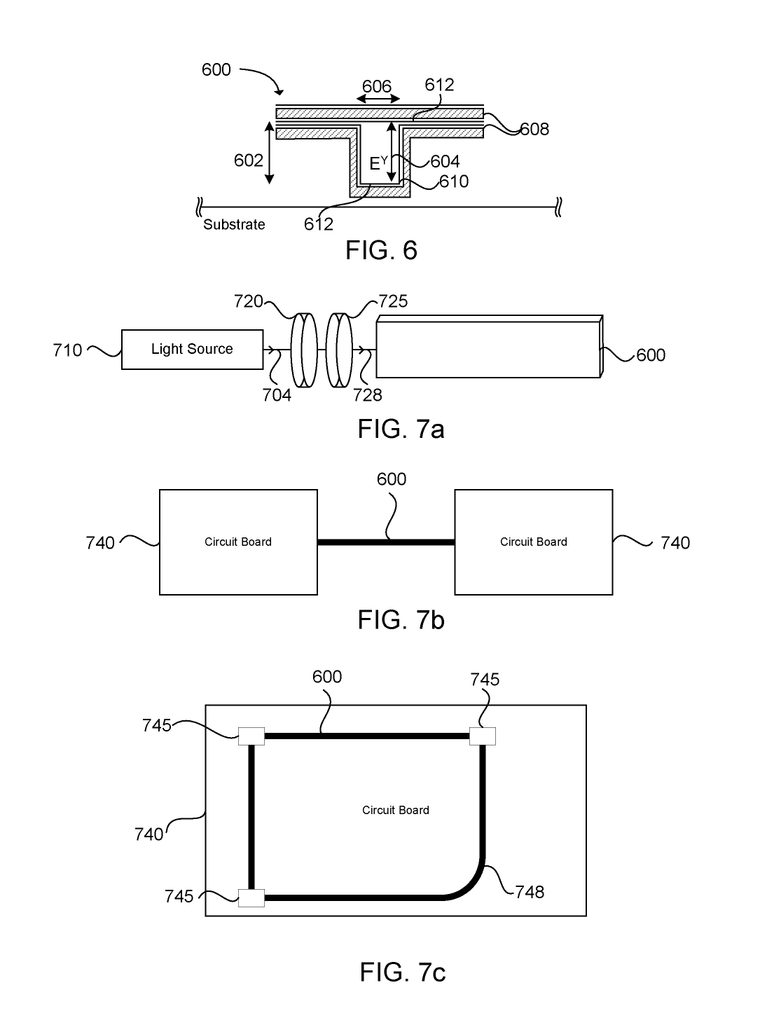

To take advantages of the lower losses and polarization maintenance available with rectangular waveguides, a large core hollow metallized waveguide 600 may be formed having a strongly elongated first dimension 602, as illustrated in FIG. 6. A second dimension 606 can be relatively perpendicular to the first dimension. For a substantially straight waveguide, polarized light can be used to transmit a polarized beam with an electric field E^{Y} 604 that is substantially parallel with the elongated dimension 602 of the waveguide. For a curved waveguide, an E^{Z} polarized beam can be directed through the curved waveguide with the electric field perpendicular to the bend plane.

The first and second dimensions of the waveguide 600 can be orthogonal to a direction of travel of light in the waveguide. The length of the waveguide walls along the first dimension 602 can be substantially greater than the length of the waveguide walls along the second dimension 606 to enable light waves with an electric field approximately parallel with the first dimension to propagate through the waveguide with substantially less loss than light waves that have an electric field approximately parallel with the second dimension. For example, in one exemplary embodiment, the elongated walls of the waveguide's first dimension can have a length of approximately 170 micrometers. The walls of the second dimension can have a length of approximately 65 micrometers. In this example, the propagation loss of a light beam travelling through the waveguide decreases as the inverse cube of the waveguide's first dimension.

A dielectric coating 610 on walls that are parallel with an electric field can be added with a selected thickness over the cladding 608. A dielectric coating 612 can also be added on the walls relative to the second dimension 606 with a selected thickness over the cladding. The thicknesses of the cladding can be selected to minimize the loss of the electromagnetic waves as they interact with the cladding.

FIG. 7a illustrates a block diagram of a photonic guiding device including a rectangular large core metallized hollow waveguide 600. The photonic guiding device can be coupled to a light source 710. The light source can be a light emitting diode, a laser, or other type of light emitting device operable to emit a light beam 704. Single mode lasers can be substantially more expensive than multi-mode lasers. Thus, using a multi-mode laser as the light source can substantially reduce the cost of the overall system. One drawback of using a multi-mode laser, however, is that a significant portion of the laser light may be emitted from the laser at fairly large angles relative to a direction the light is emitted. A higher mode of the laser light corresponds to a greater angle that the light is emitted from the laser. Light that is emitted at a large angle will reflect more often within the large core hollow waveguide 600. The greater the number of reflections, the more the light will be attenuated within the waveguide. Thus, higher modes may be substantially attenuated within the waveguide.

Hollow waveguides having reflective surfaces operate differently than solid waveguides. Hollow waveguides guide light through reflection from the reflective layer(s) and not through total internal reflection, as typically occurs in solid waveguides such as an optical fiber. The light within the hollow waveguide may be reflected at an angle less than what is necessary for total internal reflection, as can be appreciated.

To overcome the attenuation of the higher modes emitted from the light source 710, a collimator 720 can be placed within a path of the light beam 704 from the light source. In one embodiment, the light source may be a multi-mode laser. Other types of light emitters operable to emit multi-mode light may also be used. The collimator can be a collimating lens such as a ball lens with an anti-reflective coating. The collimator is configured to collimate the multi-mode beam emitted from the light source into a parallel beam before it enters the large core hollow waveguide 600. The collimator provides that substantially any reflections that do occur will typically be at a relatively shallow angle with respect to the waveguide walls, thus minimizing the number of reflections within the waveguide and therefore reducing the attenuation of the light within the hollow waveguide. As a result, the low loss mode propagating in the hollow waveguide has an extremely small numerical aperture. This property allows the insertion of optical splitters into these waveguides with little excess loss.

A polarizer 725 can be used to polarize the light beam 704. For example, the polarizer and collimator 720 can be used to form a polarized multimode light beam 728 with a polarization E^{Y} that is parallel with the long dimension of the rectangular waveguide. A beam having a wavelength of 850 nm can be transmitted through the rectangular large core waveguide having a reflective coating with a loss on the order of 0.001 dB/cm. Use of a collimating lens to direct multi-mode coherent light through the large core waveguide can also substantially reduce the cost of the overall photonic guiding device. Multimode lasers are significantly less expensive than their single mode counterparts.

Accordingly, the photonic guiding device comprising a rectangular large core hollow metallized waveguide with internal reflective surfaces that is coupled to a collimator configured to collimate multi-mode coherent light directed into the waveguide can serve as a relatively inexpensive, low loss means for interconnecting components on one or more printed circuit boards. The low loss of the guiding device enables the device to be more commonly used in commodity products, such as interconnecting electronic circuitry optically.

Electronic circuitry can include electrical circuitry, wherein electrical signals transmitted from the circuitry are converted to optical signals and vice versa. Optical circuitry can also be used that can communicate directly using optical signals without a need for conversion. The optical circuitry may include optical components designed to provide a desired type of polarization. A rectangular large core hollow metalized waveguide can be used to maintain the desired polarization as the beam is directed from one component to another component on a circuit board. The electronic and optical circuitry may be contained on a single circuit board. Alternatively, the electronic and optical circuitry may be located on two or more separate circuit boards, and the waveguide can be used to interconnect the boards. It is also relatively easy to tap and direct the optical signals from these waveguides through the use of a tilted semi-reflecting surface. This is rather difficult for conventional waveguides to achieve due to the larger numerical aperture of conventional waveguides.

For example, FIG. 7b shows a rectangular large core hollow waveguide 600 with internal reflective surfaces. The hollow waveguide is used to optically couple two circuit boards 740. The larger relative size of the hollow waveguide can reduce the cost of interconnecting the waveguide between the boards, as previously discussed. The reflective surfaces within the waveguide can reduce loss, enabling a low power signal of coherent light to be transmitted through the waveguide to the adjoining circuit board. An inexpensive multi-mode laser or other type of light emitting device, located on one or both of the circuit boards, can be used to transmit the light. A collimating lens can be included on one or both of the circuit boards and optically coupled to the waveguide. The collimating lens can reduce the losses of higher modes of light caused by multiple reflections. The use of a rectangular waveguide can further reduce loss and enable a polarized beam from the first circuit board to be maintained and communicated to the second circuit board. The rectangular hollow waveguide 600 interconnect may be configured to be coupled between the boards in a manufacturing process. Alternatively, the hollow waveguide may be formed as a connector and/or cable that can be connected to the boards after they are manufactured.

The hollow waveguide 600 with internal reflective surfaces may also be used to interconnect electronic components 745 on a single circuit board 740, as shown in FIG. 7c. The rectangular dimensions of the waveguide can reduce the area used on the circuit board for the waveguide and communicate a polarized beam with minimal loss, as previously discussed. An optical or electronic component may be used to redirect the polarized light beam from one waveguide to another. Alternatively, a curved section of waveguide, such as the ninety degree curved section 748 can be used. In one embodiment, the curved section can have a curve radius this is substantially larger than the wavelength of the light. The light beam transmitted through the curved waveguide can be polarized with an electric field in a direction that is perpendicular to the plane of the curve to minimize loss.

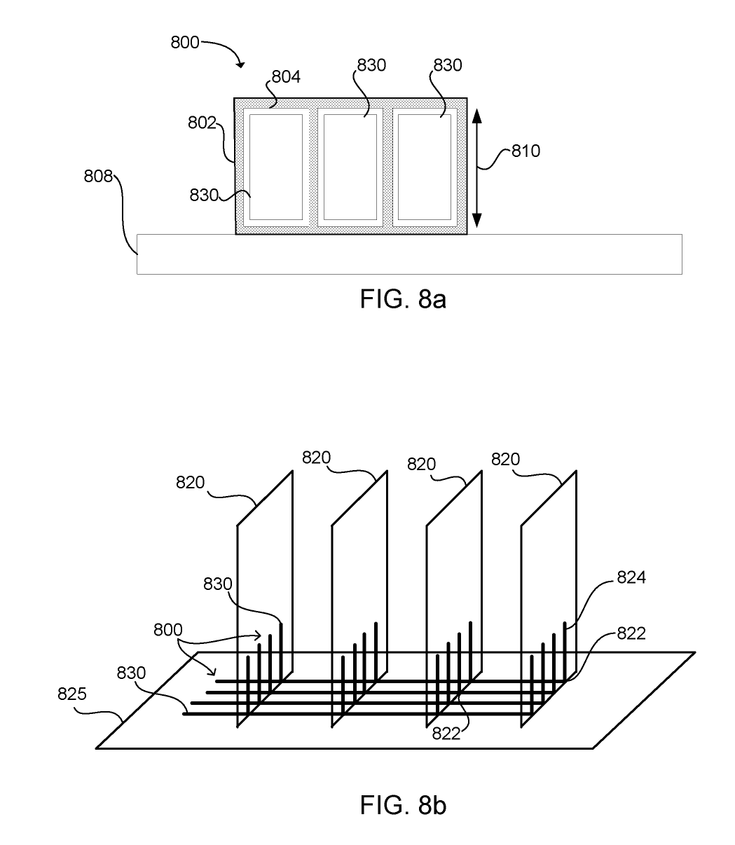

The rectangular metalized large core hollow waveguides can also be formed in an array to enable multiple signals to be directed. For example, FIG. 8a illustrates a one dimensional array 800 of rectangular hollow waveguides 830. Each waveguide can include a cladding layer 802, as previously discussed. The cladding layer can be coated with a protective layer 804 to reduce oxidation. Alternatively, the protective layer may be a dielectric layer used to reduce absorption of the light beam in the cladding layer. The array of waveguides can be constructed on a substrate or host material 808. In one embodiment, the longer dimension 810 of the rectangular waveguide can be directed away from the substrate or host material to minimize the real estate on the host material that is used by the waveguides. The polarization mode of the optical signal can be selected to minimize loss and maintain the polarization mode through the waveguide. As previously discussed, a polarization mode having an electric field that is parallel with the longer axis 810 can be used to minimize loss and maintain the polarization of the optical signal through the waveguide.

FIG. 8b illustrates an array 800 of hollow waveguides 830 coupled to a circuit board. The circuit board can act as the substrate 808 (FIG. 8a) to which each hollow waveguide in the array can be attached. In one embodiment, the circuit board can be configured as an optical backplane 825. Multi-mode coherent light can be directed into each of the waveguides using a collimator, as previously discussed. A coupling device 822, such as an optical splitter, can be configured to direct at least a portion of the guided multi-mode coherent light beam out of the waveguide at a selected location. For example, as shown in FIG. 8b, the coupling device can be used to redirect at least a portion of the coherent light in the hollow waveguide to an optically coupled large core hollow waveguide 824 that is outside the plane of the circuit board. The optically coupled waveguide may be orthogonal to the backplane, although substantially any angle may be used.

Redirecting the multi-mode coherent light out of the plane of the circuit board can enable a plurality of circuit cards, such as daughter boards 820, to be optically coupled to a backplane 825. High data rate information that is encoded on the coherent light signal can be redirected or distributed from the backplane to the plurality of daughter boards.

The rectangular large core hollow waveguides with a reflective interior coating enable transmission of high data rate information to a plurality of different boards. The low loss of the hollow waveguides enables a single optical signal to be routed into multiple other waveguides, as shown in FIG. 8b. The multi-mode coherent light beam that is guided through each waveguide can carry data at a rate of tens of gigabits per second or higher. The light beam essentially propagates at the speed of light since the index of the mode is nearly unity, resulting in a substantially minimal propagation delay. The optical interconnects enabled by the hollow waveguides provide an inexpensive means for substantially increasing throughput between chips and circuit boards. The use of rectangular waveguides enables polarized signals to be maintained and a reduction of real estate used by the waveguides on the circuit board, while maintaining the substantially low loss in the optical signal propagation.

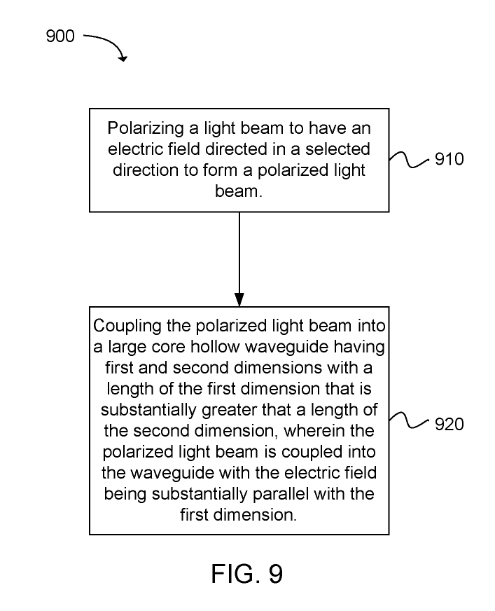

In another embodiment, a method for transmitting a polarized light beam is disclosed, as depicted in the flow chart of FIG. 9. The method includes the operation of polarizing 910 a light beam to have an electric field directed in a selected direction to form a polarized light beam. An additional operation provides for coupling 920 the polarized light beam into a large core hollow metallized waveguide. The waveguide has first and second dimensions that are substantially perpendicular to a direction of travel of the light beam in the waveguide. A length of the first dimension is substantially greater that a length of the second dimension. The polarized light beam is coupled into the large core hollow metallized waveguide with the selected direction of the electric field being substantially parallel with the first dimension to enable the polarized light beam to propagate through the waveguide with substantially less loss than if the electric field was approximately parallel with the second dimension.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A polarization maintaining photonic guiding system, comprising:
a large core hollow waveguide having first and second dimensions that are substantially perpendicular and orthogonal to a direction of travel of light in the waveguide, with a length of the first dimension that is substantially greater than a length of the second dimension to enable light waves with an electric field approximately parallel with the first dimension to propagate through the waveguide with substantially less loss than light waves that have an electric field approximately parallel with the second dimension.

2. A system as in claim 1, wherein the large core hollow waveguide is curved with a curvature radius and the light waves are polarized with an electric field that is perpendicular to a plane of the curvature to reduce propagation loss of the light waves through the waveguide.

3. A system as in claim 1, further comprising a reflective coating covering an interior of the hollow waveguide, wherein the reflective coating acts as a cladding layer and provides a high reflectivity to enable light to be reflected from a surface of the reflective coating to reduce losses that occur at reflections.

4. A system as in claim 3, further comprising a first dielectric coating having a first thickness applied to inner waveguide walls parallel with the first dimension and a second dielectric coating having a second thickness applied to inner waveguide walls parallel with the second dimension.

5. A system as in claim 4, wherein the first thickness and the second thickness are selected to maximize reflectivity of s and p polarizations of the light waves propagating in the large core hollow waveguide.

6. A system as in claim 1, further comprising a collimator configured to collimate a multi-mode light beam directed into the hollow waveguide to enable the multi-mode light beam to be guided through the hollow waveguide with a reduced number of reflections of the multi-mode light inside the hollow waveguide to decrease loss of the multi-mode light beam through the waveguide.

7. A method for transmitting a polarized light beam, comprising:
polarizing a light beam to have an electric field directed in a selected direction to form a polarized light beam;
coupling the polarized light beam into a large core hollow waveguide having first and second dimensions that are substantially perpendicular to a direction of travel of the light beam in the waveguide, with a length of the first dimension that is substantially greater than a length of the second dimension, wherein the polarized light beam is coupled into the large core hollow metallized waveguide with the selected direction of the electric field being substantially parallel with the first dimension to enable the polarized light beam to propagate through and be output from the waveguide with substantially less loss than if the electric field was approximately parallel with the second dimension to provide a polarized light beam.

8. A method as in claim 7, further comprising applying a substantially reflective coating to an interior of the hollow waveguide, wherein the reflective coating acts as a cladding layer and provides a high reflectivity to enable light to be reflected from a surface of the reflective coating to reduce losses that occur at reflections.

9. A method as in claim 8, further comprising applying a dielectric coating having a first thickness to inner waveguide walls that are substantially parallel with the first dimension and applying a dielectric coating having a second thickness to inner waveguide walls that are substantially parallel with the second dimension.

10. A method as in claim 9, further comprising selecting the first thickness and the second thickness to maximize reflectivity of s and p polarizations of the light waves propagating in the waveguide.

11. A method as in claim 7, further comprising collimating the polarized light beam to collimate a multi-mode light beam directed into the hollow waveguide to enable the multi-mode light beam to be guided through the hollow waveguide with a reduced number of reflections of the multi-mode light inside the hollow waveguide to decrease loss of the multi-mode light beam through the waveguide.

12. A photonic guiding system for polarized light, comprising:
a curved large core hollow metal waveguide with a curvature radius that is substantially greater than a wavelength of light propagating in the waveguide, the waveguide having first and second dimensions that are substantially perpendicular in a plane that is orthogonal to a direction of travel of light in the waveguide, with a length of the first dimension that is substantially greater than a length of the second dimension to enable light waves with an electric field approximately perpendicular with a plane of the curvature of the waveguide to propagate through the waveguide with substantially less loss than light waves that have an electric field approximately parallel with the plane of the curvature.

13. A system as in claim 12, further comprising a reflective coating covering an interior of the hollow waveguide, wherein the reflective coating acts as a cladding layer and provides a high reflectivity to enable light to be reflected from a surface of the reflective coating to reduce losses that occur at reflections.

14. A system as in claim 13, further comprising a first dielectric coating having a first thickness applied to inner waveguide walls parallel with the first dimension and a second dielectric coating having a second thickness applied to inner waveguide walls parallel with the second dimension.

15. A system as in claim 12, further comprising a collimator configured to collimate a multi-mode light beam directed into the curved large core hollow waveguide to enable the multi-mode coherent light beam to be guided through the curved large core hollow waveguide with a reduced number of reflections of the multi-mode coherent light inside the curved large core hollow waveguide to decrease loss of the multi-mode coherent light beam through the waveguide.
